(19) United States
(12) Patent Application Publication
(10) Pub. No.: US 2018/0105770 A1
(43) Pub. Date: Apr. 19, 2018

(54) DETERGENT COMPOSITION

(71) Applicant: The Procter & Gamble Company, Cincinnati, OH (US)

(72) Inventors: Serdar ACIKALIN, Brussels (BE); Nilgun Esin AKSOY ABACI, Meise (BE); Nathalie Sophie LETZELTER, Trimdon (GB); Rachel Elizabeth MARTIN, Newcastle upon Tyne (GB); Joke GOVAERTS, Opwijk (BE)

(21) Appl. No.: 15/786,622

(22) Filed: Oct. 18, 2017

(30) Foreign Application Priority Data
Oct. 18, 2016 (EP) 16194319.6

(51) Int. Cl. C11D 3/33; C11D 3/386; C11D 3/37; C11D 1/825; C11D 3/39; C11D 17/00

(52) U.S. Cl. CPC C11D 3/33; C11D 3/38609; C11D 17/0065; C11D 1/8255; C11D 3/3942; C11D 3/378

(57) ABSTRACT

A phosphate-free automatic dishwashing detergent composition in unit-dose form having a weight of from about 12 to about 22 grams, the composition including: i) from about 2 to about 4.5 grams of a complexing agent selected from the group consisting of methyl glycine diacetic acid, its salts and derivatives thereof, glutamic-N,N-diacetic acid, its salts and derivatives thereof, iminodisuccinic acid, its salts and derivatives thereof, carboxy methyl inulin, its salts and derivatives thereof, and mixtures thereof; ii) from about 1 mg to about 3.5 mg of active amylase; iii) from about 5 mg to about 20 mg of active protease; iv) from about 1 to about 4 grams of bleach; and about 0.2 to about 0.5 grams a sulfonated polymer.

### TECHNICAL FIELD

The present invention is in the field of cleaning. It relates to a cleaning product, in particular to a phosphate-free automatic dishwashing detergent composition comprising complexing agent and low level of sulfonated polymer. The composition provides good shine in addition to good cleaning.

### BACKGROUND OF THE INVENTION

Automatic dishwashing detergents in unit-dose form have become increasingly popular. One of the constraints of products in unit-dose form is that they have a limited volume. This volume is mainly dictated by the size of the product dispenser in the case of automatic dishwashing detergents. Traditionally automatic dishwashing detergents were based on phosphate, however due to environmental concerns the use of phosphate should be avoided.

The automatic dishwashing detergent formulator is continuously looking for ways to improve the performance of detergents. The automatic dishwashing detergent not only needs to provide good cleaning but also good finishing (lack of filming and spotting and shine). The formulator needs to take into account space constraints, in the case of unit dose products, raw materials availability, raw materials environmental profile and costs.

The objective of the present invention is to provide an automatic dishwashing detergent composition that provides: i) good cleaning; and ii) good finishing, i.e., leave the washed items free of filming and shining. The detergent should be cost effective.

### SUMMARY OF THE INVENTION

According to the first aspect of the invention, there is provided a phosphate-free automatic dishwashing detergent composition. By “phosphate-free” is herein understood that the composition comprises less than 1%, preferably less than 0.1% by weight of the composition of phosphate. The composition comprises, complexing agent, amylase and bleach in certain levels and low levels of protease and sulfonated polymer. The composition provides good cleaning and good finishing on glass, plastic and metal, in spite of the low level of sulfonated polymer. It also provides good care specially by avoiding the formation of a coloured film on stainless steel items. The composition is environmentally friendly due to the biodegradability of the complexing agent and the low level of polymer used.

The composition of the invention is in unit-dose form. By “unit-dose form” is herein meant that the composition is provided in a form sufficient to provide enough detergent for one wash. Suitable unit dose forms include tablets, sachets, capsules, pouches, etc. Preferred for use herein are compositions in unit-dose form wrapped in water-soluble material, for example polyvinyl alcohol. Especially preferred are compositions in unit dose form wrapped in a polyvinyl alcohol film having a thickness of less than 100 μm. The detergent composition of the invention weighs from about 12 to about 22 grams, preferably from about 12 to about 18 grams and more preferably from about 13 to about 17 grams. This weight range fits comfortable in a dishwasher dispenser. Even although this range amounts to a low amount of detergent, the detergent has been formulated in a way that provides all the benefits mentioned herein above.

The composition of the invention comprises a complexing agent selected from the group consisting of methyl glycine diacetic acid, its salts and derivatives thereof, glutamic-N,N-diacetic acid, its salts and derivatives thereof, iminodisuccinic acid, its salts and derivatives thereof, carboxy methyl inulin, its salts and derivatives thereof, and mixtures thereof. The preferred complexing agent for use herein is the tri-sodium salt of methyl glycine diacetic acid. The composition comprises from 2 to 4.5, preferably from 3 to 4 grams of complexing agent. For the purpose of this invention a “complexing agent” is a compound capable of binding polyvalent ions such as calcium, magnesium, lead, copper, zinc, cadmium, mercury, manganese, iron, aluminium and other cationic polyvalent ions to form a water-soluble complex. The complexing agent has a logarithmic stability constant ([log K]) for Ca2+ of at least 5, preferably at least 6. The stability constant, log K, is measured in a solution of ionic strength of 0.1, at a temperature of 25° C.

During the course of the work leading to the present invention, it was surprisingly found that in the present composition a low level of sulfonated polymer provides good finishing of the washed items. The composition of the invention provides low filming on glass, plastic and metal items, in spite of the very low level of sulfonated polymer. Even under stressed cleaning conditions such as hard water and multi-cycles.

For the purpose of this invention “dishware” encompasses tableware and cookware and anything that it is usually washed in an automatic dishwasher.

For the purpose of this invention a “sulfonated polymer” is a polymer comprising sulphur in any of its forms. The “sulfonated polymer” of the invention preferably comprises carboxyl groups.

Preferably, the complexing agent is the tri-sodium salt of MGDA and the sulfonated polymer, preferably comprises 2-acrylamido-2-methylpropane sulfonic acid, monomer.

It has been observed that some phosphate-free automatic dishwashing compositions can leave a coloured film on stainless steel items. This problem is ameliorated or even avoided when the composition of the invention is free of citrate.

The composition can be free of a crystal growth inhibitor, preferably free of 1-hydroxyethylidene 1,1-diphosphonic acid (HEDP). More preferably the composition of the invention comprises a low level of a crystal growth inhibitor, more preferably the crystal growth inhibitor is HEDP.

Preferably, the composition of the invention has a pH of from 9 to 12, more preferably from about 10 to about 11.5 as measured in 1% weight/volume aqueous solution in distilled water at 20° C.

Preferably the composition of the present invention has a reserve alkalinity of 10 or greater, preferably 12 or greater, most preferably 14 or greater. “Reserve alkalinity”, as used herein refers to, the ability of an automatic dishwashing composition to maintain an alkali pH in the presence of acid. This is relative to the ability of an automatic dishwashing composition to have sufficient alkali in reserve to deal with any added acid coming from the water and/or the soils on the dishware while maintaining the pH.

More specifically, it is defined as the grams of NaOH per 100 cc's, exceeding pH 9.5, in product. The reserve alkalinity for a solution is determined in the following manner.

A pH meter (for example An Orion Model 720A) with a Ag/AgCl electrode (for example an Orion sure flow Electrode model 9172BN) is standardized using pH 7 and pH 10 buffers. A 1% solution of the composition to be tested is prepared in distilled water. The weight of the sample is noted. The pH of the 1% solution is measured and the solution is titrated down to pH 9.5 using a solution of 0.2N HCL. The reserve alkalinity is calculated in the following fashion:

Reserve Alkalinity=% NaOH×Specific Gravity.

% NaOH=ml HCl×Normality of HCl×4′/Weight of Sample Aliquot Titrated

* Equivalent weight of NaOH in the % NaOH equation,
derived from:

% NaOH=ml HCl×Normality of HCl×Equiv. Weight NaOH×100/1000×Weight of Sample Aliquot Titrated

Cleaning using hard water is particularly challenging. According to a second aspect of the invention, there is provided a method of automatic dishwashing using the composition of the invention, preferably in hard water. Even under hard water conditions, the composition of the invention provides very good cleaning, finishing and care results. By “hard water” is herein meant water having a hardness of equal or greater than 100 ppm, preferably 200 ppm and specially 300 ppm of CaCO₃. The method of the invention also provides very good results when used in multi-cycles.

The elements of the composition of the invention described in connection with the first aspect of the invention apply mutatis mutandis to the second aspect of the invention.

### DETAILED DESCRIPTION OF THE INVENTION

The present invention encompasses an automatic dishwashing detergent composition. The composition comprises a complexing agent, preferably a salt of methyl glycine diacetic acid, more preferably the tri-sodium salt, a low level of sulfonated polymer, preferably a sulfonated polymer comprising 2-acrylamido-2-methylpropane sulfonic acid monomers, amylase and a low level of proteases and bleach, preferably sodium percarbonate. The composition provides good finishing in spite of the low level of sulfonated polymer. There is also provided a method of automatic dishwashing using the composition of the invention and a method of automatic dishwashing in hard water and under multi-cycle conditions. The composition performs really well even under hard water conditions and under multi-cycles conditions.

### Unit Dose Form

The composition of the invention is presented in unit-dose form. Products in unit dose form include tablets, capsules, sachets, pouches, injection moulded containers, etc. Preferably, the composition is in a pack made of water-soluble material. Preferred packs are pouches, where the detergent composition is enveloped by a water-soluble film and injection moulded containers wherein the detergent composition is placed in a container of water-soluble material made by injection moulding. Both the detergent composition and the enveloping material are water-soluble. They readily dissolve when exposed to water in an automatic dishwashing process, preferably during the main wash. The pack can have a single compartment or a plurality of compartments. The compartments can comprise a composition in liquid or solid form.

Preferably, the unit dose detergent can by in the form of a multi-compartment pack. By “multi-compartment pack” is herein meant a pack having at least two compartments, preferably at least three compartments, each compartment contains a composition surrounded by enveloping material, preferably polyvinyl alcohol. The compartments can be in any geometrical disposition. The different compartments can be adjacent to one another, preferably in contact with one another. Especially preferred configurations for use herein include superposed compartments (i.e. one above the other), side-by-side compartments, etc. Especially preferred from a view point of automatic dishwasher dispenser fit, stability and enveloping material reduction are multi-compartment pouches or containers having some superposed compartments and/or some side-by-side compartments.

### Enveloping Material

The enveloping material is water soluble. By “water-soluble” is herein meant that the material has a water-solubility of at least 50%, preferably at least 75% or even at least 95%, as measured by the method set out herein after using a glass-filter with a maximum pore size of 20 microns.

50 grams+−0.1 gram of enveloping material is added in a pre-weighed 400 ml beaker and 245 ml+−1 ml of distilled water is added. This is stirred vigorously on a magnetic stirrer set at 600 rpm, for 30 minutes at 20° C. Then, the mixture is filtered through a folded qualitative sintered-glass filter with a pore size as defined above (max, 20 micron). The water is dried off from the collected filtrate by any conventional method, and the weight of the remaining material is determined (which is the dissolved or dispersed faction). Then, the % solubility can be calculated.

The enveloping material is any water-soluble material capable of enclosing the cleaning composition of the product of the invention. The enveloping material can be a polymer that has been injection moulded to provide a casing or it can be a film. Preferably the enveloping material is made of polyvinyl alcohol. Preferably the enveloping material is a water-soluble polyvinyl alcohol film.

The pouch can, for example, be obtained by injection moulding or by creating compartments using a film. The enveloping material is usually moisture permeable. The pouch of the invention is stable even when the enveloping material is moisture permeable. The liquid composition confers stability to the pouch, in terms of both interaction among the different compositions and interaction with the surrounding environment.

Preferred substances for making the enveloping material include polymers, copolymers or derivatives thereof selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Especially preferred for use herein is polyvinyl alcohol and even more preferred polyvinyl alcohol films.

Most preferred enveloping materials are PVA films known under the trade reference Monosol M8630, as sold by Kuraray, and PVA films of corresponding solubility and deformability characteristics. Other films suitable for use herein include films known under the trade reference PT film or the K-series of films supplied by Aicello, or VF-HP film supplied by Kuraray.

The enveloping material herein may comprise other additive ingredients than the polymer or polymer material and water. For example, it may be beneficial to add plasticisers, for example glycerol, ethylene glycol, diethyleneglycol, propylene glycol, dipropylene glycol, sorbitol and mixtures thereof. Preferably the enveloping material comprises glycerol as plasticisers. Other useful additives include disintegrating aids.

### Detergent Composition

The detergent composition of the invention is presented in unit-dose form and it can be in any physical form including solid, liquid and gel form. The composition of the invention is very well suited to be presented in the form of a multi-compartment pack, more in particular a multi-compartment pack comprising compartments with compositions in different physical forms, for example a compartment comprising a composition in solid form and another compartment comprising a composition in liquid form. The composition is preferably enveloped by a water-soluble film such as polyvinyl alcohol. The composition comprises an complexing agent, preferably the tri-sodium salt of MGDA, a low level of sulfonated polymer preferably comprising 2-acrylamido-2-methylpropane sulfonic acid monomers, low level of protease and amylase enzymes, a bleach, preferably sodium percarbonate, and preferably an inorganic builder, more preferably carbonate, a bleach activator, a bleach catalyst, non-ionic surfactant, a crystal growth inhibitor, more preferably HEDP. The composition is preferably free of citrate.

The composition of the invention preferably has a pH as measured in 1% weight/volume aqueous solution in distilled water at 20° C. of from about 9 to about 12, more preferably from about 10 to less than about 11.5 and especially from about 10.5 to about 11.5.

The composition of the invention preferably has a reserve alkalinity of from about 10 to about 20, more preferably from about 12 to about 18 at a pH of 9.5 as measured in NaOH with 100 mL of product at 20° C.

### Complexing Agent

A complexing agent is a material capable of sequestering hardness ions, particularly calcium and/or magnesium.

The composition of the invention comprises from 2 to 4.5 grams, preferably from 2.5 to 4 grams of a complexing agent. The complexing agent is selected from the group consisting of methyl-glycine-diacetic acid, its salts and derivatives thereof, glutamic-N,N-diacetic acid, its salts and derivatives thereof, iminodisuccinic acid, its salts and derivatives thereof, carboxy methyl inulin, its salts and derivatives thereof and mixtures thereof. Especially preferred complexing agent for use herein is a salt of MGDA, in particular the three sodium salt of MGDA.

### Sulfonated Polymer

The composition of the invention comprises low level of sulfonated polymer, from 0.2 to 0.5 grams and preferably from 0.25 to 0.45 grams, preferably the sulfonated polymer comprises 2-acrylamido-2-methylpropane sulfonic acid monomers and carboxyl monomers.

The composition is preferably free of other dispersant polymers.

Suitable sulfonated polymers described herein may have a weight average molecular weight of less than or equal to about 100,000 Da, preferably less than or equal to about 75,000 Da, more preferably less than or equal to about 50,000 Da, more preferably from about 3,000 Da to about 50,000, and specially from about 5,000 Da to about 45,000 Da.

The sulfonated polymers preferably comprises carboxylic acid monomers and sulfonated monomers. Preferred carboxylic acid monomers include one or more of the following: acrylic acid, maleic acid, itaconic acid, methacrylic acid, or ethoxylate esters of acrylic acids, acrylic and methacrylic acids being more preferred. Preferred sulfonated monomers include one or more of the following: sodium (meth) allyl sulfonate, vinyl sulfonate, sodium phenyl (meth) allyl ether sulfonate, or 2-acrylamido-methyl propane sulfonic acid. Preferred non-ionic monomers include one or more of the following: methyl (meth) acrylate, ethyl (meth) acrylate, t-butyl (meth) acrylate, methyl (meth) acrylamide, ethyl (meth) acrylamide, t-butyl (meth) acrylamide, styrene, or α-methyl styrene.

Specially preferred sulfonated polymers for use herein are those comprising monomers of acrylic acid and monomers of 2-acrylamido-methyl propane sulfonic acid.

In the polymers, all or some of the carboxylic or sulfonic acid groups can be present in neutralized form, i.e. the acidic hydrogen atom of the carboxylic and/or sulfonic acid group in some or all acid groups can be replaced with metal ions, preferably alkali metal ions and in particular with sodium ions.

Preferred commercial available polymers include: Alcosperse 240, Aquatreat AR 540 and Aquatreat MPS supplied by Alco Chemical; Acumer 3100, Acumer 2000, Acusol 587G and Acusol 588G supplied by Rohm & Haas; Goodrich K-798, K-775 and K-797 supplied by BF Goodrich; and ACP 1042 supplied by ISP technologies Inc. Particularly preferred polymers are Acusol 587G and Acusol 588G supplied by Rohm & Haas, Versaflex Si™ (sold by Alco Chemical, Tennessee, USA) and those described in U.S. Pat. No. 5,308,532 and in WO 2005/090541.

Suitable styrene co-polymers may be selected from the group comprising, styrene co-polymers with acrylic acid and optionally sulphonate groups, having average molecular weights in the range 1,000-50,000, or even 2,000-10,000 such as those supplied by Alco Chemical Tennessee, USA, under the tradenames Alcosperse® 729 and 747.

Other dispersant polymers useful herein include the cellulose sulfate esters such as cellulose acetate sulfate, cellulose sulfate, hydroxyethyl cellulose sulfate, methylcellulose sulfate, and hydroxypropylcellulose sulfate. Sodium cellulose sulfate is the most preferred polymer of this group.

Other suitable dispersant polymers are the carboxylated polysaccharides, particularly starches, celluloses and alginates. Preferred cellulose-derived dispersant polymers are the carboxymethyl celluloses.

Yet another group of acceptable dispersing agents are the organic dispersing polymers, such as polyaspartates.

Amphilic graft co-polymer are useful for use herein. Suitable amphilic graft co-polymer comprises (i) polyethylene glycol backbone; and (ii) and at least one pendant moiety selected from polyvinyl acetate, polyvinyl alcohol and mixtures thereof. In other examples, the amphilic graft copolymer is Sokalan HP22, supplied from BASF.

### Bleach

The composition of the invention preferably comprises from 1 to 4, preferably from 1.2 to 3 and especially from 1.5 to 2.5 grams of bleach.

Inorganic and organic bleaches are suitable for use herein. Inorganic bleaches include perhydrate salts such as perborate, percarbonate, perphosphate, persulfate and persilicate salts. The inorganic perhydrate salts are normally the alkali metal salts. The inorganic perhydrate salt may be included as the crystalline solid without additional protection. Alternatively, the salt can be coated. Suitable coatings include sodium sulphate, sodium carbonate, sodium silicate and mixtures thereof. Said coatings can be applied as a mixture applied to the surface or sequentially in layers.

Alkali metal percarbonates, particularly sodium percarbonate is the preferred bleach for use herein. The percarbonate is most preferably incorporated into the products in a coated form which provides in-product stability.

Potassium peroxymonopersulfate is another inorganic perhydrate salt of utility herein.

Typical organic bleaches are organic peroxyacids, especially diperoxydodecanedioc acid, diperoxytetradecanedioc acid, and diperoxyhexadecanedioc acid. Mono- and diperazelaic acid, mono- and diperbrassylic acid are also suitable herein. Diacyl and Tetraacylperoxides, for instance dibenzoyl peroxide and dilauroyl peroxide, are other organic peroxides that can be used in the context of this invention.

Further typical organic bleaches include the peroxyacids, particular examples being the alkylperoxy acids and the arylperoxy acids. Preferred representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

Preferably, the level of bleach in the composition of the invention is from about 0 to about 10%, more preferably from about 0.1 to about 5%, even more preferably from about 0.5 to about 3% by weight of the composition.

### Bleach Activators

Bleach activators are typically organic peracid precursors that enhance the bleaching action in the course of cleaning at temperatures of 60° C. and below. Bleach activators suitable for use herein include compounds which, under perhydrolysis conditions, give aliphatic peroxoycarboxylic acids having preferably from 1 to 12 carbon atoms, in particular from 2 to 10 carbon atoms, and/or optionally substituted perbenzoic acid. Suitable substances bear O-acyl and/or N-acyl groups of the number of carbon atoms specified and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), decanoyloxybenzoic acid (DOBA), carboxylic anhydrides, in particular phthalic anhydride, acylated polyhydric alcohols, in particular triacetin, ethylene glycol diacetate and 2,5-diacetoxy-2,5-dihydrofuran and also triethylacetyl citrate (TEAC). If present the composition of the invention comprises from 0.1 to 2, preferably from 0.2 to 1 grams of bleach activator, preferably TAED.

### Bleach Catalyst

The composition herein preferably contains a bleach catalyst, preferably a metal containing bleach catalyst. More preferably the metal containing bleach catalyst is a transition metal containing bleach catalyst, especially a manganese or cobalt-containing bleach catalyst.

Bleach catalysts preferred for use herein include the manganese triazacyclononane and related complexes (U.S. Pat. No. 4,246,612, U.S. Pat. No. 5,227,084); Co, Cu, Mn and Fe bispyridylamine and related complexes (U.S. Pat. No. 5,114,611); and pentamine acetate cobalt(III) and related complexes (U.S. Pat. No. 4,810,410). A complete description of bleach catalysts suitable for use herein can be found in WO 99/06521, pages 34, line 26 to page 40, line 16.

Manganese bleach catalysts are preferred for use in the composition of the invention. Especially preferred catalyst for use here is a dinuclear manganese-complex having the general formula:

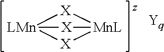

wherein Mn is manganese which can individually be in the III or IV oxidation state; each x represents a coordinating or bridging species selected from the group consisting of H2O, O22-, O2-, OH—, HO2-, SH—, S2-, >SO, Cl—, N3-, SCN—, RCOO—, NH2- and NR3, with R being H, alkyl or aryl, (optionally substituted); L is a ligand which is an organic molecule containing a number of nitrogen atoms which coordinates via all or some of its nitrogen atoms to the manganese centres; z denotes the charge of the complex and is an integer which can be positive or negative; Y is a monovalent or multivalent counter-ion, leading to charge neutrality, which is dependent upon the charge z of the complex; and q=z/[charge Y].

Preferred manganese-complexes are those wherein x is either CH₃COO⁻ or O² or mixtures thereof, most preferably wherein the manganese is in the IV oxidation state and x is O²⁻. Preferred ligands are those which coordinate via three nitrogen atoms to one of the manganese centres, preferably being of a macrocyclic nature. Particularly preferred ligands are:
(1) 1,4,7-trimethyl-1,4,7-triazacyclononane, (Me-TACN); and
(2) 1,2,4,7-tetramethyl-1,4,7-triazacyclononane, (Me-Me TACN).

The type of counter-ion Y for charge neutrality is not critical for the activity of the complex and can be selected from, for example, any of the following counter-ions: chloride; sulphate; nitrate;

methylsulphate; surfactant anions, such as the long-chain alkylsulphates, alkylsulphonates, alkylbenzenesulphonates, tosylate, trifluoromethylsulphonate, perchlorate (ClO₄⁻), BPh₄⁻, and PF₆⁻¹ though some counter-ions are more preferred than others for reasons of product property and safety.

Consequently, the preferred manganese complexes useable in the present invention are:
(I) [(Me-TACN)Mn^{IV}(Âμ-0)₃Mn^{IV}(Me-TACN)]²⁺(PF₆⁻)₂
(II) [(Me-MeTACN)Mn^{IV}(Âμ-0)₃Mn^{IV}(Me-MeTACN)]²⁺(PF₆⁻)₂
(III) [(Me-TACN)Mn^{III}(Âμ-0)(Âμ-OAc)₂Mn^{III}(Me-TACN)]²⁺(PF₆⁻)₂
(IV) [(Me-MeTACN)Mn^{III}(Âμ-0)(Âμ-OAc)₂Mn^{III}(Me-MeTACN)]²⁺(PF₆⁻)₂
   which hereinafter may also be abbreviated as:
(I) [Mn^{IV}₂ (Âμ-0)₃(Me-TACN)₂] (PF₆)₂
(II) [Mn^{IV}₂ (Âμ-0)₃(Me-MeTACN)₂] (PF₆)₂
(III) [Mn^{III}₂(Âμ-0) (Âμ-OAc)₂(Me-TACN)₂] (PF₆)₂
(IV) [Mn^{III}₂(Âμ-0) (Âμ-OAc)₂(Me-TACN)₂](PF₆)₂

The structure of I is given below:

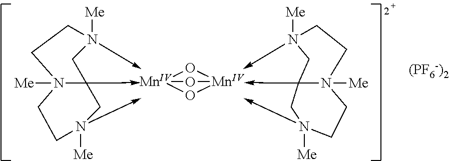

abbreviated as [Mn^{IV}₂(Âμ-0)₃(Me-TACN)₂] (PF₆)₂.

The structure of II is given below:

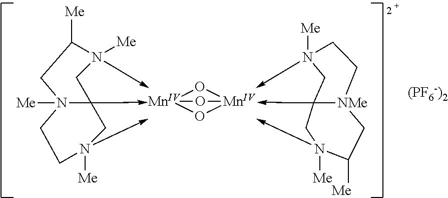

abbreviated as [Mn^{IV}₂(Âμ-0)₃(Me-MeTACN)₂] (PF₆)₂.

It is of note that the manganese complexes are also disclosed in EP-A-0458397 and EP-A-0458398 as unusually effective bleach and oxidation catalysts. In the further description of this invention they will also be simply referred to as the “catalyst”.

Preferably the composition of the invention comprises from 0.001 to 1, more preferably from 0.002 to 0.01 grams of bleach catalyst. Preferably the bleach catalyst is a manganese bleach catalyst.

### Inorganic Builder

The composition of the invention preferably comprises an inorganic builder. Suitable inorganic builders are selected from the group consisting of carbonate, silicate and mixtures thereof. Especially preferred for use herein is sodium carbonate. Preferably the composition of the invention comprises from 1 to 8, more preferably from 2 to 6 and especially from 3 to 5 grams of calcium carbonate.

### Surfactant

Surfactants suitable for use herein include non-ionic surfactants, preferably the compositions are free of any other surfactants. Traditionally, non-ionic surfactants have been used in automatic dishwashing for surface modification purposes in particular for sheeting to avoid filming and spotting and to improve shine. It has been found that non-ionic surfactants can also contribute to prevent redeposition of soils.

Preferably the composition of the invention comprises a non-ionic surfactant or a non-ionic surfactant system, more preferably the non-ionic surfactant or a non-ionic surfactant system has a phase inversion temperature, as measured at a concentration of 1% in distilled water, between 40 and 70° C., preferably between 45 and 65° C. By a “non-ionic surfactant system” is meant herein a mixture of two or more non-ionic surfactants. Preferred for use herein are non-ionic surfactant systems. They seem to have improved cleaning and finishing properties and better stability in product than single non-ionic surfactants.

Phase inversion temperature is the temperature below which a surfactant, or a mixture thereof, partitions preferentially into the water phase as oil-swollen micelles and above which it partitions preferentially into the oil phase as water swollen inverted micelles. Phase inversion temperature can be determined visually by identifying at which temperature cloudiness occurs.

The phase inversion temperature of a non-ionic surfactant or system can be determined as follows: a solution containing 1% of the corresponding surfactant or mixture by weight of the solution in distilled water is prepared. The solution is stirred gently before phase inversion temperature analysis to ensure that the process occurs in chemical equilibrium. The phase inversion temperature is taken in a thermostable bath by immersing the solutions in 75 mm sealed glass test tube. To ensure the absence of leakage, the test tube is weighed before and after phase inversion temperature measurement. The temperature is gradually increased at a rate of less than 1° C. per minute, until the temperature reaches a few degrees below the pre-estimated phase inversion temperature. Phase inversion temperature is determined visually at the first sign of turbidity.

Suitable nonionic surfactants include: i) ethoxylated non-ionic surfactants prepared by the reaction of a monohydroxy alkanol or alkyphenol with 6 to 20 carbon atoms with preferably at least 12 moles particularly preferred at least 16 moles, and still more preferred at least 20 moles of ethylene oxide per mole of alcohol or alkylphenol; ii) alcohol alkoxylated surfactants having a from 6 to 20 carbon atoms and at least one ethoxy and propoxy group. Preferred for use herein are mixtures of surfactants i) and ii).

Another suitable non-ionic surfactants are epoxy-capped poly(oxyalkylated) alcohols represented by the formula:

R1O[CH2CH(CH3)O]x[CH2CH2O]y[CH2CH(OH)R2] (I)

wherein R1 is a linear or branched, aliphatic hydrocarbon radical having from 4 to 18 carbon atoms; R2 is a linear or branched aliphatic hydrocarbon radical having from 2 to 26 carbon atoms; x is an integer having an average value of from 0.5 to 1.5, more preferably about 1; and y is an integer having a value of at least 15, more preferably at least 20.

Preferably, the surfactant of formula I, at least about 10 carbon atoms in the terminal epoxide unit [CH2CH(OH)R2]. Suitable surfactants of formula I, according to the present invention, are Olin Corporation's POLY-TERGENT® SLF-18B nonionic surfactants, as described, for example, in WO 94/22800, published Oct. 13, 1994 by Olin Corporation.

Amine oxides surfactants are useful for use in the composition of the invention. Preferred are C10-C18 alkyl dimethylamine oxide, and C10-18 acylamido alkyl dimethylamine oxide.

Surfactants may be present in amounts from 0.1 to 10, more preferably from 0.5 to 5 and especially from 0.8 to 3 grams.

### Enzymes

In describing enzyme variants herein, the following nomenclature is used for ease of reference: Original amino acid(s):position(s):substituted amino acid(s). Standard enzyme IUPAC 1-letter codes for amino acids are used.

### Proteases

Suitable proteases include metalloproteases and serine proteases, including neutral or alkaline microbial serine proteases, such as subtilisins (EC 3.4.21.62) as well as chemically or genetically modified mutants thereof. Suitable proteases include subtilisins (EC 3.4.21.62), including those derived from Bacillus, such as Bacillus lentus, B. alkalophilus, B. subtilis, B. amyloliquefaciens, Bacillus pumilus and Bacillus gibsonii.

Especially preferred proteases for the detergent of the invention are polypeptides demonstrating at least 90%, preferably at least 95%, more preferably at least 98%, even more preferably at least 99% and especially 100% identity with the wild-type enzyme from Bacillus lentus, comprising mutations in one or more, preferably two or more and more preferably three or more of the following positions, using the BPN′ numbering system and amino acid abbreviations as illustrated in WO00/37627, which is incorporated herein by reference: V68A, N87S, S99D, S99SD, S99A, S101G, S101M, S103A, V104N/I, G118V, G118R, S128L, P129Q, S130A, Y167A, R1705, A194P, V2051 and/or M222S.

Most preferably the protease is selected from the group comprising the below mutations (BPN′ numbering system) versus either the PB92 wild-type (SEQ ID NO:2 in WO 08/010925) or the subtilisin 309 wild-type (sequence as per PB92 backbone, except comprising a natural variation of N87S).
(i) G118V+S128L+P129Q+S130A
(ii) S101M+G118V+S128L+P129Q+S130A
(iii) N76D+N87R+G118R+S128L+P129Q+S130A+S188D+N248R
(iv) N76D+N87R+G118R+S128L+P129Q+S130A+S188D+V244R
(v) N76D+N87R+G118R+S128L+P129Q+S130A
(vi) V68A+N87S+S101G+V104N

Suitable commercially available protease enzymes include those sold under the trade names Savinase®, Polarzyme®, Kannase®, Ovozyme®, Everlase® and Esperase® by Novozymes A/S (Denmark), those sold under the tradename Properase®, Purafect®, Purafect Prime®, Purafect Ox®, FN3®, FN4®, Excellase®, Ultimase® and Purafect OXP® by Genencor International, those sold under the tradename Opticlean® and Optimase® by Solvay Enzymes, those available from Henkel/Kemira, namely BLAP.

Preferred levels of protease in the product of the invention include from 5 to 20, more preferably from 8 to 15 mg of active protease.

### Amylases

Preferred enzyme for use herein includes alpha-amylases, including those of bacterial or fungal origin. Chemically or genetically modified mutants (variants) are included. A preferred alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, DSM 9375 (U.S. Pat. No. 7,153,818) DSM 12368, DSMZ no. 12649, KSM AP1378 (WO 97/00324), KSM K36 or KSM K38 (EP 1,022,334). Preferred amylases include:
(a) the variants described in U.S. Pat. No. 5,856,164 and WO99/23211, WO 96/23873, WO00/60060 and WO 06/002643, especially the variants with one or more substitutions in the following positions versus the AA560 enzyme listed as SEQ ID No. 12 in WO 06/002643:
9, 26, 30, 33, 82, 37, 106, 118, 128, 133, 149, 150, 160, 178, 182, 186, 193, 195, 202, 214, 231, 256, 257, 258, 269, 270, 272, 283, 295, 296, 298, 299, 303, 304, 305, 311, 314, 315, 318, 319, 320, 323, 339, 345, 361, 378, 383, 419, 421, 437, 441, 444, 445, 446, 447, 450, 458, 461, 471, 482, 484, preferably that also contain the deletions of D183* and G184*.
(b) variants exhibiting at least 95% identity with the wild-type enzyme from Bacillus sp.707 (SEQ ID NO:7 in U.S. Pat. No. 6,093,562), especially those comprising one or more of the following mutations M202, M208, 5255, R172, and/or M261. Preferably said amylase comprises one of M202L or M202T mutations.

Suitable commercially available alpha-amylases include DURAMYL®, LIQUEZYME®, TERMAMYL®, TERMAMYL ULTRA®, NATALASE®, SUPRAMYL®, STAINZYME®, STAINZYME PLUS®, POWERASE®, FUNGAMYL® and BAN® (Novozymes A/S, Bagsvaerd, Denmark), KEMZYM® AT 9000 Biozym Biotech Trading GmbH Wehlistrasse 27b A-1200 Wien Austria, RAPIDASE®, PURASTAR®, ENZYSIZE®, OPTISIZE HT PLUS® and PURASTAR OXAM® (Genencor International Inc., Palo Alto, Calif.) and KAM® (Kao, 14-10 Nihonbashi Kayabacho, 1-chome, Chuo-ku Tokyo 103-8210, Japan). Amylases especially preferred for use herein include NATALASE®, STAINZYME®, STAINZYME PLUS®, POWERASE® and mixtures thereof.

Preferably, the product of the invention comprises at least 1 mg, preferably from 2 to about 3.5, more preferably from about 2 to about 3 mg of active amylase.

### Additional Enzymes

Additional enzymes suitable for use in the product of the invention can comprise one or more enzymes selected from the group comprising hemicellulases, cellulases, cellobiose dehydrogenases, peroxidases, proteases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, ß-glucanases, arabinosidases, hyaluronidase, chondroitinase, laccase, amylases, and mixtures thereof.

Preferably, the protease and/or amylase of the product of the invention are in the form of granulates, the granulates comprise less than 29% of sodium sulfate by weight of the granulate or the sodium sulfate and the active enzyme (protease and/or amylase) are in a weight ratio of less than 4:1.

### Crystal Growth Inhibitor

Crystal growth inhibitors are materials that can bind to calcium carbonate crystals and prevent further growth of species such as aragonite and calcite.

Especially preferred crystal growth inhibitor for use herein is HEDP (1-hydroxyethylidene 1,1-diphosphonic acid). Preferably, the composition of the invention comprises from 0.01 to 1, more preferably from 0.05 to 0.8 grams of a crystal growth inhibitor, preferably HEDP.

### Metal Care Agents

Metal care agents may prevent or reduce the tarnishing, corrosion or oxidation of metals, including aluminium, stainless steel and non-ferrous metals, such as silver and copper. Preferably the composition of the invention comprises from 0.001 to 0.01, more preferably from 0.002 to 0.009 grams, preferably the metal care agent is benzo triazole (BTA).

### Glass Care Agents

Glass care agents protect the appearance of glass items during the dishwashing process. Preferably the composition of the invention comprises from 0.001 to 1, more preferably from 0.002 to 0.5 grams of a glass care agent, preferably the glass care agent is a zinc salt.

### Examples

Automatic dishwashing compositions were made comprising the ingredients detailed herein below (Composition 1 (comparative) Composition 2 (according to the invention), Composition 3 (according to the invention) and Composition 4 (comparative)). The powder and liquid components of the compositions were prepared and added in the dishwashers from separate glass vials.

| Ingredients | Composition | Composition | Composition | Composition |
|---|---|---|---|---|
| (active grams) | 1 | 2 | 3 | 4 |
| Powder | | | | |
| MGDA | 3.30 | 3.90 | 4.10 | 4.30 |
| Sulfonated | 1.30 | 0.40 | 0.40 | — |
| Polymer | | | | |
| Sodium | 4.00 | 4.00 | 4.00 | 4.00 |
| carbonate | | | | |
| Amylase | 0.003 | 0.003 | 0.003 | 0.003 |
| Protease | 0.011 | 0.011 | 0.011 | 0.011 |
| Sodium | 2.60 | 2.60 | 2.60 | 2.60 |
| Percarbonate | | | | |
| Bleach catalyst | 0.221 | 0.221 | 0.221 | 0.221 |
| and bleach | | | | |
| activator | | | | |
| HEDP | 0.10 | 0.10 | 0.10 | 0.10 |
| Miscellaneous | Balance to | Balance to | Balance to | Balance to |
| | 14.11 | 14.11 | 14.11 | 14.11 |
| Liquid | | | | |
| Plurafac | 0.49 | 0.49 | 0.49 | 0.49 |
| SLF-180 | | | | |
| Lutensol T07 | 0.47 | 0.47 | 0.47 | 0.47 |
| Miscellaneous | Balance to | Balance to | Balance to | Balance to |
| | 1.14 | 1.14 | 1.14 | 1.14 |

| | |
|---|---|
| MGDA | Tri-sodium salt of methyl glycine diacetic acid. |
| Sulfonated polymer | Acusol 588 available from Dow Chemicals |
| Amylase | Amylase available from Novozymes |
| Protease | Protease available from DuPont |
| Bleach activator | TAED (Tetraacetylethylenediamine) |
| Bleach catalyst | Manganese bleach catalyst |
| HEDP | 1-hydroxyethylidene 1,1-diphosphonic acid |
| Plurafac SLF-180 | Nonionic surfactant supplied by BASF |
| Lutensol TO7 | Nonionic surfactant supplied by BASF |

### Multi-Cycle Filming

A multi-cycle filming test was conducted under the following test conditions.

Test conditions: 5 cycles at 55° C., followed by 25 cycles at 65° C., Universal cycle-Miele dishwashers-, water hardness 360 CaCO₃ ppm. As artificial ballast 50 g frozen soil (composition specified in the table below) was introduced at the beginning of each cycle, in order to reproduce a cycle in soiled conditions. The soil was prepared by blending all the ingredients to form a paste, then it is divided in pots containing 50 g of paste each and stored in a freezer.

| Ingredient | Weight (gr) |
|---|---|
| Potato Starch | 56 |
| Wheat Flour | 45 |
| Vegetable oil | 44 |
| Margarine | 44 |
| Lard | 44 |
| Single Cream | 90 |
| Baking Spread | 44 |
| Large Eggs | 90 |
| Whole Milk | 90 |
| Ketchup | 31 |
| Mustard | 41 |
| Benzoic acid | 8 |
| Hard Water (360 CaCO3 ppm) | 375 |
| Total | 1000 |

Different materials representing what is usually washed in a dishwasher were used: ceramic plates, glasses, plastic containers, stainless steel cutleries and plastic tumblers. Materials were visually assessed under daylight in order to detect major faults. Stronger artificial light is used to detect minor faults using image analysis (IA). The following scales were used for:
Visual assessment using daylight for Stainless steel cutlery, plastic and ceramic plate examination; Film: from 1 to 4 (1 is heavily filmed and 4 is no film at all)
Image analysis using artificial light for glass and plastic tumbler examination; % Clarity Index via Image Analysis: Clarity Index (%)=100−100*[Mean Film Gray Level (GL)]/255=percent of the way from 0 to 255. A Clarity Index of 100 would occur with a completely dark glass with a gray level of zero. A Clarity Index of 0 would occur with a completely solid white glass with a gray level of 255. The smaller the difference between the initial clarity of an item and the clarity after 30 cycles the less filming on the item.

The assessment of the filming was carried out after thirty wash cycles.

Composition 2 and 3, according to the invention, showed similar performance in the case of stainless steel cutlery and better performance on filming in the case of ceramic plates as compared to Composition 1. This was surprising as the polymer level was considerably lower in the composition of the invention than in the comparative Composition 1. As illustrated by Composition 4, filming performance gets worse with removal of polymer. Composition 2 and 3 showed similar filming performance

| | Film grades After 30 cycles | |
|---|---|---|
| Visual assessment | Stainless steel cutlery | Ceramic plate |
| Composition 1 | 4 | 3.8 |
| Composition 2 | 4 | 4.4 |
| Composition 3 | 4 | 4.3 |
| Composition 4 | 2 | 3.9 |

| | Glass | | | | | Plastic tumbler | | | | |
|---|---|---|---|---|---|---|---|---|---|---|
| | | | | | Difference | | | | | Difference |
| | Clarity Index (%) | | | | in | Clarity Index (%) | | | | in |
| Image | 0 | St. | 30 | St. | Clarity | 0 | St. | 30 | St. | Clarity |
| analysis | Cycle | Dev. | Cycle | Dev. | Index | Cycle | Dev. | Cycle | Dev. | Index |
| Composition 1 | 95.1 | 0.1 | 85.1 | 0.5 | −10 | 89.4 | 0.7 | 81.3 | 1.4 | −8.1 |
| Composition 2 | 94.9 | 0.3 | 87.8 | 1 | −7.1 | 86.5 | 1 | 78.8 | 0.6 | −7.7 |
| Composition 3 | 94.7 | 0.4 | 87.9 | 0.6 | −6.8 | 88.1 | 0.8 | 80.9 | 1 | −7.2 |
| Composition 4 | 94.8 | 0.2 | 82.8 | 0.4 | −12 | 89.2 | 0.2 | 65.2 | 1 | −24 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A phosphate-free automatic dishwashing detergent composition in unit-dose form having a weight of from 12 to 22 grams, the composition comprising:
i) from 2 to 4.5 grams of a complexing agent selected from the group consisting of methyl glycine diacetic acid, its salts and derivatives thereof, glutamic-N,N-diacetic acid, its salts and derivatives thereof, iminodisuccinic acid, its salts and derivatives thereof, carboxy methyl inulin, its salts and derivatives thereof, and mixtures thereof;
ii) from 1 mg to 3.5 mg of active amylase;
iii) from 5 mg to 20 mg of active protease;
iv) from 1 to 4 grams of bleach; and
v) 0.2 to 0.5 grams a sulfonated polymer.

2. A composition according to claim 1 wherein the complexing agent is selected from the group consisting of methyl glycine diacetic acid, its salts and derivatives thereof.

3. A composition according to claim 1 wherein the complexing agent is the tri-sodium salt of methyl glycine diacetic acid.

4. A composition according to claim 1 wherein the composition is substantially free of citrate.

5. A composition according to claim 1 further comprising from about 0.05 to about 0.8 grams of a crystal growth inhibitor.

6. A composition according to claim 1 further comprising a bleach activator.

7. A composition according to claim 1 further comprising an inorganic builder.

8. A composition according to claim 1 further comprising an inorganic builder wherein the builder is calcium carbonate.

9. A composition according to claim 1 further comprising a non-ionic surfactant.

10. A composition according to claim 1 wherein the weight of the unit-dose is from 12 to 18 grams and wherein the composition comprises:
i) from about 3 to about 4 grams of the tri-sodium salt of methyl glycine diacetic acid; and
ii) from about 1 to about 3 grams of sodium percarbonate;
iii) from about 0.05 to about 0.2 grams of HEDP; and
iv) from about 3 to about 5 grams of sodium carbonate.

11. A composition according to claim 1 having a pH equal or greater than about 9 to about 12 as measured in 1% weight/volume aqueous solution at 20° C.

12. A composition according to claim 1 having a reserve alkalinity equal or greater than about 10 to about 20 at a pH of 9.5 as measured in NaOH with 100 mL of product at 20° C.

13. A method of cleaning dishware in an automatic dishwasher comprising the step of subjecting the dishware to a wash liquor comprising a composition according to claim 1.

14. A method of cleaning dishware in an automatic dishwasher comprising the step of subjecting the dishware to a wash liquor comprising a composition according to claim 1 wherein the method is performed using water having a hardness of more than 100 ppm of CaCO₃.

15. A method of cleaning dishware in an automatic dishwasher comprising the step of subjecting the dishware to a wash liquor comprising a composition according to claim 1 wherein the dishware is subjected to more than 10 cycles.
